(19) United States
(12) Patent Application Publication
(10) Pub. No.: US 2009/0206749 A1
(43) Pub. Date: Aug. 20, 2009

(54) DISPLAY DEVICE AND MANUFACTURING METHOD THEREOF

(75) Inventors: Noriharu Matsudate, Kujukuri (JP); Takeshi Ookawara, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/369,805

(22) Filed: Feb. 12, 2009

(30) Foreign Application Priority Data
Feb. 14, 2008 (JP) 2008-032502

(51) Int. Cl. H01J 1/53; H01J 9/02

(52) U.S. Cl. 313/505; 445/46

(57) ABSTRACT

A display device includes plural pixels each including a pixel electrode and a transparent electrode formed above the pixel electrode and an auxiliary wiring formed between light emitting regions each in each of the pixels on the transparent electrode, in which the auxiliary wiring is a metal wiring in a stripe shape formed on a resin. The transparent electrode is formed in common with each of the pixels, and a sheet resistance obtained by combining the transparent electrode with the metal wiring is 10 Ω/□ or less. The metal wiring is Cu, Al or SUS. A blackening treatment is applied to the metal wiring. The transparent electrode is ITO, IZO or ZnO. The metal wiring is formed in a non-light emitting region between the light emitting regions in each of the pixels in an extending direction of a scanning line. The resin is PET, TAC or POC.

### CROSS-REFERENCE TO RELATED APPLICATIONS

The present application claims priority from Japanese Application JP 2008-32502 filed on Feb. 14, 2008, the content of which is hereby incorporated by reference into this application.

### BACKGROUND OF THE INVENTION

1. Field of the Invention

The present invention relates to a display device and a manufacturing method thereof and more particularly to a forming method of an auxiliary wiring in an organic electroluminescent display device.

2. Description of the Related Art

In a top emission type organic electroluminescent display device, since a pixel portion can be designed above a thin film transistor used for driving a pixel (hereinafter referred to as “drive TFT”) or a wiring, and therefore there is no influence of the area of the drive TFT or wiring, a pixel aperture ratio can be increased. Therefore, the top emission type organic electroluminescent display device has such an advantage that the higher resolution or higher luminance of the organic electroluminescent display panel can be achieved, or that power consumption can be reduced.

However, it involves problems that a metal oxide such as ITO or IZO must be used for an upper transparent electrode (common electrode) present in a light extraction direction, and also that the electric resistance of the metal oxide is higher than that of a metal such as Al (aluminum). That is, because of the high resistance of the upper transparent electrode, voltage drop occurs at the center and periphery of the screen of the organic electroluminescent display panel. Therefore, it is difficult to ensure the uniformity of luminance.

In order to reduce the resistance of the upper transparent electrode, a method has been adopted in which a metal of low resistance, such as Al, is finely wired above or below the upper transparent electrode and connected to the transparent electrode, whereby the electric resistance of the upper transparent electrode is reduced as a whole (refer to Patent Documents 1 to 3, listed below).

Related art documents relating to the invention of the present application are as follows.

Patent Document 1: JP-A-2007-103058

Patent Document 2: JP-A-2007-103098

Patent Document 3: JP-A-2007-108469

### SUMMARY OF THE INVENTION

When the above-described fine metal wiring of low resistance is defined as an auxiliary wiring, the preparing method of the auxiliary wiring can be mainly classified into the following two methods.

(1) Manufacturing the auxiliary wiring used below a transparent electrode by photo process

(2) Preparing a metal of low resistance, such as Al, below or above a transparent electrode by deposition

In the former case, a change in the manufacturing process due to an increase in the number of photo processes and an increase in cost are inevitable.

In the latter case, on the other hand, it is easily conceivable that when the metal of low resistance, such as Al, is deposited, the damage to an organic electroluminescent element due to the elevation of temperature of a deposition mask or substrate, the displacement of the auxiliary wiring due to the degradation of deposition accuracy, or the like occurs because the metal of low resistance, such as Al, is a high melting point metal. Further, the problem of the deterioration in display quality due to the diffused reflection of external light or the like is also conceivable because the metal of low resistance, such as Al, has metal gloss.

The invention has been made to solve the problems in the related art, and it is an object of the invention to provide a technique enabling the formation of an auxiliary wiring on a common electrode with high accuracy without damaging a light emitting layer in a display device and a manufacturing method thereof.

A typical outline of the invention disclosed in the present application will be described below.

(1) A display device includes: a plurality of pixels each including a pixel electrode and a transparent electrode formed above the pixel electrode; and an auxiliary wiring formed between light emitting regions each in each of the pixels on the transparent electrode, in which the auxiliary wiring is a metal wiring in a stripe shape formed on a resin.

(2) In (1), the transparent electrode is formed in common with each of the pixels, and a sheet resistance obtained by combining the transparent electrode with the metal wiring is 10 Ω/□ or less.

(3) In (1) or (2), the metal wiring is Cu, Al or SUS.

(4) In any of (1) to (3), a blackening treatment is applied to the metal wiring.

(5) In any of (1) to (4), the transparent electrode is ITO, IZO or ZnO.

(6) In any of (1) to (5), the display device further includes a scanning line which inputs a scanning voltage to each of the pixels, in which the metal wiring is formed in a non-light emitting region between light emitting regions each in each of the pixels in an extending direction of the scanning line.

(7) In any of (1) to (6), the display device further includes a separation wall which separates each of the pixels, in which the light emitting region in each of the pixels is separated by the separation wall for each of the pixels, and the metal wiring is formed above the transparent electrode above the separation wall.

(8) In any of (1) to (7), the resin is PET, TAC or POC.

(9) A method of manufacturing a display device including: a plurality of pixels each having a pixel electrode and a transparent electrode formed above the pixel electrode; and an auxiliary wiring formed between light emitting regions each in each of the pixels on the transparent electrode, the method includes the steps of: preparing a resin having a metal wiring formed in a stripe shape on a main surface thereof; forming the pixel electrode above a substrate; forming the transparent electrode above the pixel electrode; and bonding the prepared resin on the transparent electrode such that the main surface faces the transparent electrode to form the auxiliary wiring between the light emitting regions each in each of the pixels on the transparent electrode.

(10) In (9), the step of preparing the resin having the metal wiring formed in a stripe shape on the main surface thereof includes the step of forming a metal material on the main surface of the resin, and the step of etching the metal material by photo etching to form the metal wiring in a stripe shape.

(11) In (9), the step of preparing the resin having the metal wiring formed in a stripe shape on the main surface thereof is the step of forming the metal wiring in a stripe shape on the main surface of the resin by a printing method or a deposition method.

(12) In any of (9) to (11), the method further includes the step of forming a separation wall which separates the light emitting region in each of the pixels after the step of forming the pixel electrode above the substrate, in which the step of forming the transparent electrode above the pixel electrode is the step of forming the transparent electrode so as to cover the separation wall in common with each of the pixels.

A typical effect obtained by the invention disclosed in the present application will be briefly described below.

According to the invention, an auxiliary wiring can be formed on a common electrode with high accuracy without damaging a light emitting layer.

### BRIEF DESCRIPTION OF THE DRAWINGS

FIG. 1 is a circuit diagram showing an equivalent circuit of one pixel (sub-pixel) of an organic electroluminescent display panel serving as the premise of the invention;

FIG. 2 is a schematic cross sectional view showing a cross sectional structure of a main portion of one pixel of the organic electroluminescent display panel serving as the premise of the invention;

FIG. 3 shows an example of a constitution of an organic electroluminescent element (OLE) shown in FIG. 2;

FIG. 4 shows an arrangement pattern of an auxiliary wiring (SUP) shown in FIG. 2;

FIG. 5 is an explanatory view of an auxiliary wiring constituting member according to an embodiment of the invention;

FIG. 6 is a perspective view showing the auxiliary wiring constituting member according to the embodiment of the invention in an enlarged manner;

FIG. 7 is a schematic cross sectional view showing a state before bonding the auxiliary wiring constituting member shown in FIGS. 5 and 6 with an organic electroluminescent display panel not formed with the auxiliary wiring (SUP) in the structure shown in FIG. 2;

FIG. 8 is a schematic cross sectional view showing a state after bonding the auxiliary wiring constituting member shown in FIGS. 5 and 6 with the organic electroluminescent display panel not formed with the auxiliary wiring (SUP) in the structure shown in FIG. 2;

FIG. 9 is an explanatory view of a problem caused when the auxiliary wiring (SUP) is formed on a common electrode (CD) by a conventional process; and

FIG. 10 is an explanatory view of a problem caused when the auxiliary wiring (SUP) is formed below the common electrode (CD) by the conventional process.

### DESCRIPTION OF THE PREFERRED EMBODIMENTS

Hereinafter, an embodiment of the invention will be described in detail with reference to the drawings.

Throughout the drawings for explaining the embodiment, the same reference numerals are assigned to elements having the same functions, and the repetitive description thereof is omitted.

In the embodiment, an example in which the invention is applied to a top emission type active matrix organic electroluminescent display device will be described.

### [Organic Electroluminescent Display Panel Serving as the Premise of the Invention]

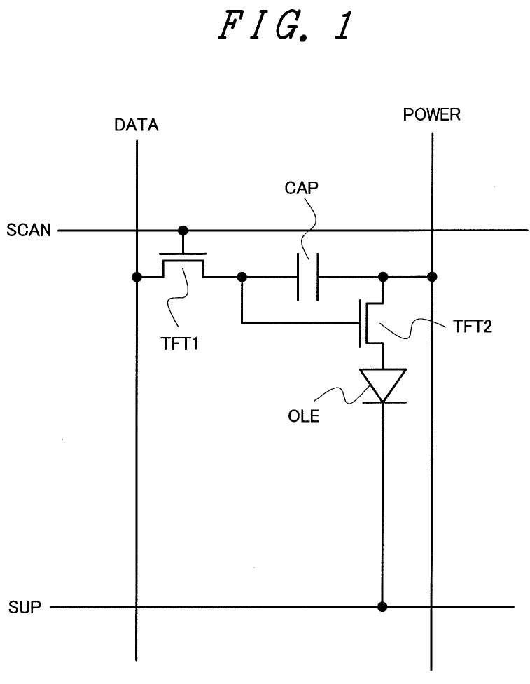

FIG. 1 is a circuit diagram showing an equivalent circuit of one pixel (sub-pixel) of an organic electroluminescent display panel serving as the premise of the invention.

As shown in FIG. 1, in the organic electroluminescent display panel serving as the premise of the invention, a video line (DATA) and a power supply line (POWER) are disposed in the vertical direction, an auxiliary wiring (SUP) and a scanning line (SCAN) are disposed in the horizontal direction, and each of pixels is formed among these wirings.

Each of the pixels includes a first transistor (TFT1), a second transistor (TFT2), a data holding capacitor (CAP), and an organic electroluminescent element (OLE).

The first transistor (TFT1) is connected to the video line (DATA) at one end of the source/drain region thereof, connected to one end of the data holding capacitor (CAP) at the other end of the source/drain region thereof, and connected to the scanning line (SCAN) at the gate thereof as a control terminal.

The end of the data holding capacitor (CAP) is also connected to the control terminal of the second transistor (TFT2), and the other end of the data holding capacitor (CAP) is connected to the power supply line (POWER).

Not only the data holding capacitor (CAP) but also one end of the source/drain region of the second transistor (TFT2) is connected to the power supply line (POWER). The other end of the source/drain region of the second transistor (TFT2) is connected to the anode of the organic electroluminescent element (OLE). The cathode of the organic electroluminescent element (OLE) is connected to the auxiliary wiring (SUP).

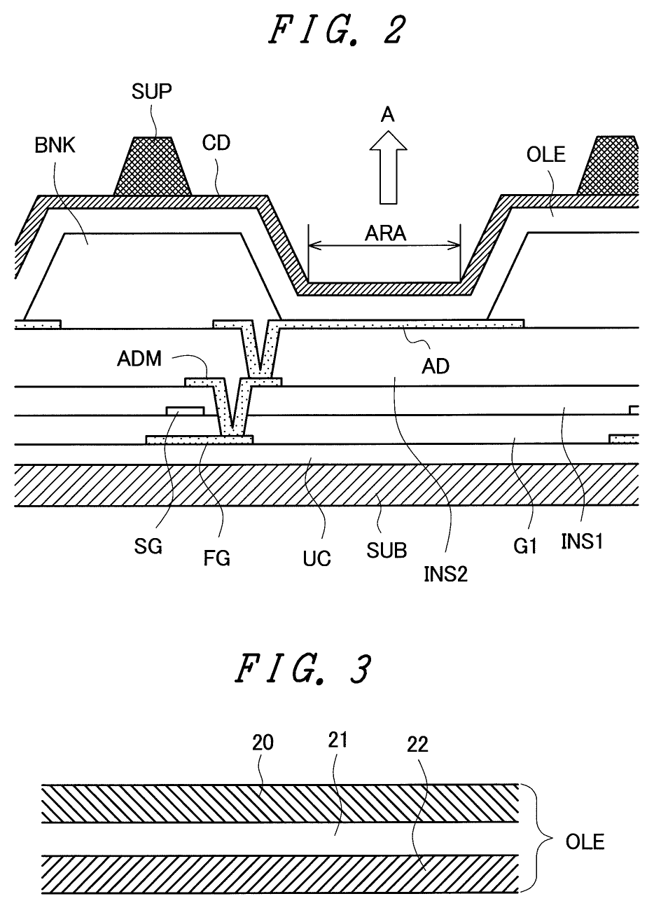

FIG. 2 shows a cross sectional structure of a main portion of one pixel of the organic electroluminescent display panel serving as the premise of the invention.

As shown in FIG. 2, in the organic electroluminescent display panel serving as the premise of the invention, a base film (UC), a semiconductor film (FG), a gate insulating film (GI), a metal gate electrode film (SG), a first inter-layer insulating film (INS1), a metal electrode film (ADM), a second inter-layer insulating film (INS2), a pixel electrode (AD), a bank (BNK), the auxiliary wiring (SUP), the organic electroluminescent element (OLE), and a common electrode (CD) are formed above a substrate (SUB). In FIG. 2, an arrow A shows the irradiation direction of light emitted from the organic electroluminescent element (OLE).

The substrate (SUB) is a non-alkali glass with a thickness of 0.5 mm.

The base film (UC) is provided for avoiding the influence of ionic impurities contained in the substrate (SUB) on a thin film transistor (TFT) constituting the first transistor (TFT1) or the second transistor (TFT2) and includes a stacked film of a silicon nitride film with a thickness of from 50 to 200 nm and a silicon oxide film with a thickness of from 50 to 200 nm.

The semiconductor film (FG) is a layer constituting not only the source region, drain region, and channel region of the thin film transistor (TFT) which constitutes the first transistor (TFT1) or the second transistor (TFT2) but also a wiring due to heavy doping or the lower electrode of the data holding capacitor (CAP). The semiconductor film (FG) is composed of polysilicon with a thickness of from 50 to 150 nm.

The gate insulating film (GI) includes a silicon oxide film with a thickness of from 100 to 200 nm formed of TEOS, covering the entire surface of the substrate except for a contact hole. The gate insulating film (GI) functions not only as a gate insulating film but also as a dielectric layer of the data holding capacitor (CAP).

The metal gate electrode film (SG) serves as the gate electrode of the first transistor (TFT1) and the gate electrode of the second transistor (TFT2) as well as is a layer constituting the upper electrode of the scanning line (SCAN) and the data holding capacitor (CAP). The metal gate electrode film (SG) is a metal film with a thickness of from 100 to 300 nm and includes an alloy film (MoW) of molybdenum (Mo) and tungsten (W).

The first inter-layer insulating film (INS1) includes a silicon oxide film with a thickness of from 200 to 500 nm, covering the entire surface of the substrate except for a contact hole.

The metal electrode film (ADM) constitutes not only the video line (DATA) and the power supply line (POWER) but also a wiring upon connecting the semiconductor film (FG) with the metal gate electrode film (SG) or a redundant wiring to reduce resistance. The metal electrode film (ADM) includes a metal film with a stacked structure having an AlSi film with a thickness of about from 200 to 400 nm interposed between a MoW film with a thickness of about from 20 to 120 nm and a MoW film with a thickness of about from 50 to 150 nm.

The second inter-layer insulating film (INS2) has a stacked structure in which an organic insulating film, made of one selected from polyimide, acrylic, and epoxy, with a thickness of from 1 μm to 2 μm is formed on a silicon nitride film with a thickness of from 300 to 500 nm, covering the entire surface of the substrate except for a contact hole.

The pixel electrode (AD) includes two (upper and lower) layers. The lower layer includes a stacked film of an AlSi film with a thickness of from 50 to 200 nm and a MoW film with a thickness of about from 20 to 120 nm (AlSi film for upper layer and MoW film for lower layer) and is separated for each pixel. The upper layer includes an ITO (Indium Tin Oxide) film with a thickness of about from 30 to 200 nm and is separated for each pixel. The upper layer ITO covers the lower layer metal and is electrically connected directly to the second transistor (TFT2) not by way of the lower layer. That is, the upper layer of the pixel electrode (AD) functions as an anode for hole injection while the lower layer functions as a reflective film which reflects light emitted from the organic electroluminescent element (OLE).

The bank (BNK) is an insulating film which covers the outer edge of the pixel electrode (AD) and insulates light emitting regions (ARA) from each other, the light emitting regions (ARA) each exposing the pixel electrode (AD), and composed of silicon nitride (SiN), acrylic, or polyimide.

As shown in FIG. 3, the organic electroluminescent element (OLE) includes at least three layers of a hole transport layer 22, a light emitting layer 21, and an electron transport layer 20. At least one layer of the organic electroluminescent element (OLE) is also formed on the bank.

The common electrode (CD) serving as a cathode includes a zinc based oxide conductive film such as of IZO, covering the entire surface of the organic electroluminescent element (OLE).

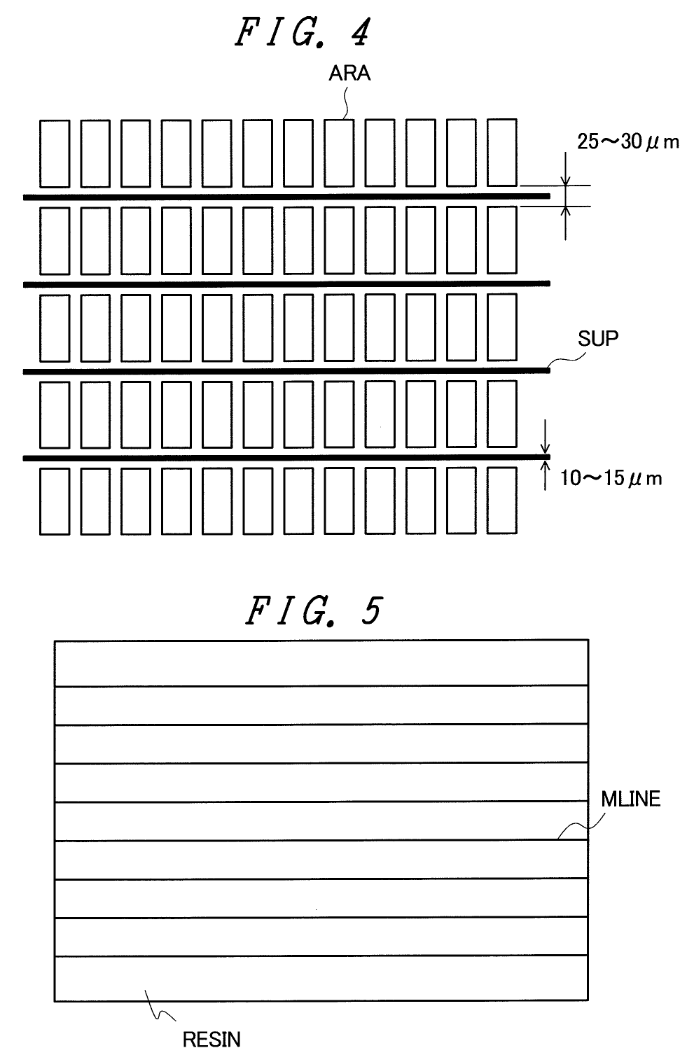

The auxiliary wiring (SUP) is formed on the common electrode (CD). The auxiliary wiring (SUP) is formed in a non-light emitting region between the light emitting regions (ARA) each in each pixel in the extending direction of the scanning line (SCAN). That is, the auxiliary wiring (SUP) is formed on the banks (BNK) extending from side to side among the banks (BNK) extending from side to side and up and down. FIG. 4 shows the plane pattern of the auxiliary wiring (SUP). As shown in FIG. 4, the wiring width of the auxiliary wiring (SUP) is set to from 10 to 15 μm, and the distance between the light emitting regions (ARA) each in each pixel is set to from 25 to 30 μm.

In this manner, in the top emission type organic electroluminescent display device, the pixel electrode (AD) and the organic electroluminescent element (OLE) can be formed above the first transistor (TFT1), the second transistor (TFT2), and each wiring. Therefore, the pixel aperture ratio can be increased, so that the top emission type organic electroluminescent display device has such an advantage that the higher resolution or higher luminance of the organic electroluminescent display panel can be achieved, or that power consumption can be reduced.

As described above, the auxiliary wiring (SUP) is used for the purpose of reducing the resistance of the common electrode (CD). Therefore, a metal having a sufficiently lower electric resistance than that of ITO, IZO or ZnO which is the material for the common electrode (CD) must be used for the auxiliary wiring (SUP). Therefore, Al, which is easily available at present and has a low electric resistance, and whose film formation method is stabilized, is used for the auxiliary wiring (SUP).

In the case of using Al for the material of the auxiliary wiring, however, the temperature of a deposition source is 1500 K or more when a usual resistance heating or induction heating method is used because Al is a high melting point metal. Therefore, damage to the organic electroluminescent element (OLE) or the like becomes a problem due to the elevation of temperature of a high-resolution deposition mask or the elevation of temperature of a substrate and further the contact between a deposition mask heated to a high temperature and the organic electroluminescent element (OLE). The damage to the organic electroluminescent element (OLE) is a problem relating to the reliability of the organic electroluminescent display panel, for which a sufficient countermeasure must be taken.

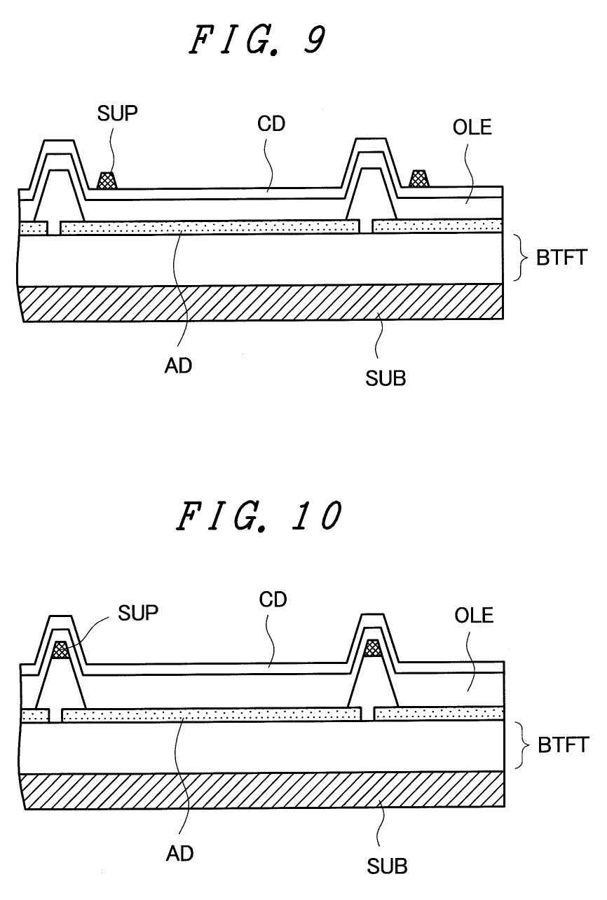

On the other hand, the influence of the elevation of temperature of a deposition mask or substrate causes the thermal expansion of the deposition mask or substrate, leading to a problem of deposition displacement of a film forming position of the auxiliary wiring (SUP). The deposition displacement causes display failure as a product when the displacement exceeds a design margin, that is, when the auxiliary wiring (SUP) is shifted and deposited on a pixel. FIG. 9 shows this state schematically.

When the auxiliary wiring (SUP) is formed below the organic electroluminescent element (OLE), it is unnecessary to consider the damage to the organic electroluminescent element (OLE) due to the elevation of temperature of a high-resolution deposition mask or the elevation of temperature of a substrate and further the contact between a deposition mask heated to a high temperature and the organic electroluminescent element (OLE). Therefore, the patterning of the auxiliary wiring (SUP) with high accuracy is possible by photolithography.

However, when the auxiliary wiring (SUP) is formed below the organic electroluminescent element (OLE), the organic film interferes with the connection between the auxiliary wiring (SUP) and the common electrode (CD) because the organic film is present therebetween. FIG. 10 shows this state schematically.

This becomes a problem not only in a color organic electroluminescent display device in which single color emission is combined with a color filter but also in an organic electroluminescent display device adopting the so-called “solid deposition” in which, even for multicolor emission, at least one layer constituting a light-emitting material layer is commonly deposited also for a different color pixel in order to simplify the process. In FIGS. 9 and 10, the structure between the substrate (SUB) and the pixel electrode (AD) shown in FIG. 2 is represented by BTFT, and the illustration of the structure between the substrate (SUB) and the pixel electrode (AD) shown in FIG. 2 is omitted.

### [Feature of Organic Electroluminescent Display Panel According to Embodiment of the Invention]

An organic electroluminescent display panel according to the embodiment of the invention has a feature of constituting an auxiliary wiring constituting member with a different part from the organic electroluminescent display panel and combining the organic electroluminescent display panel with the auxiliary wiring constituting member.

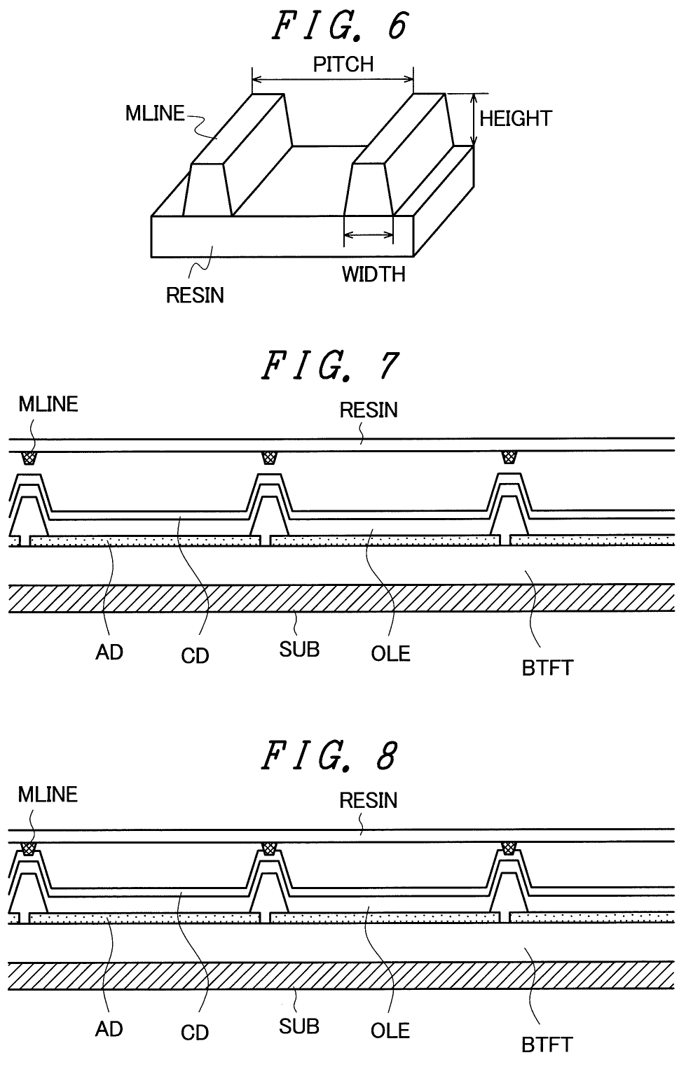

FIG. 5 is an explanatory view of an auxiliary wiring constituting member according to the embodiment of the invention, and FIG. 6 is a perspective view showing the auxiliary wiring constituting member according to the embodiment of the invention in an enlarged manner.

The auxiliary wiring constituting member shown in FIGS. 5 and 6 includes a resin film (RESIN) composed of PET (PolyEthylene Terephthalate) and a metal wiring (MLINE) formed into a stripe shape on the resin film (RESIN).

The auxiliary wiring constituting member is prepared by, for example, bonding a copper foil reduced to a thickness of 10 μm or less by cold rolling with a PET film by a decorative steel sheet technique, then etching the copper foil by an etching technique which jets an etching solution at a high temperature under a high pressure to fabricate the metal wiring (MLINE) such that the taper angle thereof is from 80 to 90 degree, and forming the metal wiring (MLINE) into a stripe shape.

When this process is used, the metal wiring (MLINE) having a wiring pitch (PITCH) of from 80 to 1000 μm, a wiring width (WIDTH) of from 8 to 50 μm, and a wiring height (HEIGHT) of from 10 to 150 μm can be manufactured appropriately.

Accordingly, when the process is used, a resolution of about 300 LPI (Line per inch) can be sufficiently achieved for the metal wiring (MLINE). Therefore, the process provides a sufficient fabrication degree for the purpose of forming the pattern of the auxiliary wiring (SUP) of the organic electroluminescent display panel.

Further, since a metal used for the pattern of the metal wiring (MLINE) has a wiring thickness of about 10 μm of a plate thickness, the electric resistance is reduced to about 1/10 compared with that of a metal wiring patterned above a general glass substrate by photo process and having a thickness of about 1 μm. Therefore, the auxiliary wiring (SUP) according to the embodiment shows the lowest wiring resistance compared with that obtained by a conceivable forming process of the auxiliary wiring under current situation, that is, a photo process method or a vacuum deposition method.

In the embodiment, ITO, IZO or ZnO is used as the common electrode (CD). In the embodiment, when ITO, IZO or ZnO is used as the common electrode (CD), and the auxiliary wiring constituting member is combined with the common electrode (CD) of the organic electroluminescent display panel, the sheet resistance obtained by combining the common electrode (CD) with the auxiliary wiring (SUP) can be reduced to 10 Ω/□ or less.

As a result, voltage drop due to the wiring resistance of the auxiliary wiring (SUP) can be reduced more than in the past, which contributes to the manufacture of a high-performance organic electroluminescent display panel. In addition, it becomes possible to easily cope with an increase in the size of a top emission type organic electroluminescent display panel (for example, organic electroluminescent display panel of 17 inches or more).

The metal wiring (MLINE) is an opaque metal film, for which a metal material such as copper (Cu) or stainless steel (SUS) can be used in addition to aluminum (Al). A blackening treatment may be applied to the surface of the metal wiring (MLINE). In this case, the visible characteristics of an organic electroluminescent display panel can be improved.

As the resin film (RESIN), TAC (triacetylcellulose), POC (polyolefin copolymer) or the like can be applied in addition to PET. Other material can also be used as long as a film has a low birefringence like those of the above resins.

In the above description, the auxiliary wiring constituting member is manufactured by preparing a member previously obtained by bonding a metal foil and a resin film together, patterning the prepared member by photoresist, and removing a portion other than the wiring by an etching method. However, similar effect can be obtained also by using a deposition method or a printing method.

In the embodiment, the auxiliary wiring constituting member shown in FIGS. 5 and 6 and the organic electroluminescent display panel not formed with the auxiliary wiring (SUP) in the structure shown in FIG. 2 are respectively separately manufactured.

Thereafter, the resin film (RESIN) is bonded on the organic electroluminescent display panel not formed with the auxiliary wiring (SUP) in the structure shown in FIG. 2 by pressure bonding, for example, by vacuum lamination such that the metal wiring (MLINE) is not overlaid with the light emitting region (ARA).

In this case, since the deposited layer of the organic electroluminescent display panel is a thin film and mainly includes an organic layer, the elasticity of the deposited layer is higher than that of the metal wiring (MLINE) of the resin film (RESIN). Therefore, the metal wiring (MLINE) of the resin film (RESIN) bites into the common electrode (CD) of the organic electroluminescent display panel.

FIG. 7 shows a state before bonding the auxiliary wiring constituting member shown in FIGS. 5 and 6 with the organic electroluminescent display panel not formed with the auxiliary wiring (SUP) in the structure shown in FIG. 2 while FIG. 8 shows a state after bonding the auxiliary wiring constituting member shown in FIGS. 5 and 6 with the organic electroluminescent display panel not formed with the auxiliary wiring (SUP) in the structure shown in FIG. 2.

As shown in FIG. 8, after bonding the auxiliary wiring constituting member shown in FIGS. 5 and 6 with the organic electroluminescent display panel not formed with the auxiliary wiring (SUP) in the structure shown in FIG. 2, a usual sealing process of an organic electroluminescent display panel is performed, whereby an organic electroluminescent display panel is completed.

In FIGS. 7 and 8, the structure between the substrate (SUB) and the pixel electrode (AD) shown in FIG. 2 is represented by BTFT, and the illustration of the structure between the substrate (SUB) and the pixel electrode (AD) shown in FIG. 2 is omitted.

According to the embodiment, the following operation and advantages can be obtained.

(1) The process of elevating a substrate temperature at the time of film deposition of the auxiliary wiring (SUP) is no more required, whereby it is possible to prevent the damage to the organic electroluminescent element (OLE) at the time of forming the auxiliary wiring (SUP).

(2) Owing to the process of bonding the resin film (RESIN) formed with the metal wiring (MLINE) with high accuracy with an organic electroluminescent display panel, the auxiliary wiring (SUP) can be formed to the organic electroluminescent display panel with the accuracy of alignment process, enabling the improvement in the forming accuracy of the auxiliary wiring (SUP), that is, the suppression of displacement of the auxiliary wiring (SUP).

(3) Applying a blackening treatment to the metal wiring (MLINE) blackens the surface of the auxiliary wiring (SUP) to suppress optical reflectivity, whereby it is possible to improve black level when light is not emitted like in the case of BM (black matrix) in a CRT and improve the contrast.

(4) The resin film (RESIN) formed with the metal wiring (MLINE) with high accuracy has an electromagnetic wave absorption effect as it is, whereby it is possible to suppress unnecessary radiation (electromagnetic wave).

(5) The process of vapor depositing the metal wiring (MLINE), a vacuum apparatus or photo process is no more required, and an easy process, like the bonding of a color filter in a liquid crystal display, is only required, whereby it is possible to provide an effect of reducing the number of processes as well as to reduce the cost due to the improvement in yield.

As described above, according to the embodiment, it is possible to form the auxiliary wiring (SUP) with high accuracy without damaging the organic electroluminescent element (OLE), whereby it is possible to improve the performance and production yield of a top emission type organic electroluminescent display panel.

Although the invention made by the present inventor has been described specifically based on the embodiment, the invention is not limited to the embodiment. It is apparent that the invention can be variously modified within the range not departing from the gist of the invention.

What is claimed is:

1. A display device comprising:
a plurality of pixels each including a pixel electrode and a transparent electrode formed above the pixel electrode; and
an auxiliary wiring formed between light emitting regions each in each of the pixels on the transparent electrode, wherein
the auxiliary wiring is a metal wiring in a stripe shape formed on a resin.

2. The display device according to claim 1, wherein
the transparent electrode is formed in common with each of the pixels, and
a sheet resistance obtained by combining the transparent electrode with the metal wiring is 10 Ω/□ or less.

3. The display device according to claim 1, wherein
the metal wiring is Cu, Al or SUS.

4. The display device according to claim 1, wherein
a blackening treatment is applied to the metal wiring.

5. The display device according to claim 1, wherein
the transparent electrode is ITO, IZO or ZnO.

6. The display device according to claim 1, further comprising a scanning line which inputs a scanning voltage to each of the pixels, wherein
the metal wiring is formed in a non-light emitting region between the light emitting regions each in each of the pixels in an extending direction of the scanning line.

7. The display device according to claim 1, further comprising a separation wall which separates each of the pixels, wherein
the light emitting region in each of the pixels is separated by the separation wall for each of the pixels, and
the metal wiring is formed above the transparent electrode above the separation wall.

8. The display device according to claim 1, wherein
the resin is PET, TAC or POC.

9. A method of manufacturing a display device including:
a plurality of pixels each having a pixel electrode and a transparent electrode formed above the pixel electrode; and
an auxiliary wiring formed between light emitting regions each in each of the pixels on the transparent electrode, the method comprising the steps of:
preparing a resin having a metal wiring formed in a stripe shape on a main surface thereof;
forming the pixel electrode above a substrate;
forming the transparent electrode above the pixel electrode; and
bonding the prepared resin on the transparent electrode such that the main surface faces the transparent electrode to form the auxiliary wiring between the light emitting regions each in each of the pixels on the transparent electrode.

10. The method of manufacturing a display device according to claim 9, wherein
the step of preparing the resin having the metal wiring formed in a stripe shape on the main surface thereof includes the step of forming a metal material on the main surface of the resin, and
the step of etching the metal material by photo etching to form the metal wiring in a stripe shape.

11. The method of manufacturing a display device according to claim 9, wherein
the step of preparing the resin having the metal wiring formed in a stripe shape on the main surface thereof is the step of forming the metal wiring in a stripe shape on the main surface of the resin by a printing method or a deposition method.

12. The method of manufacturing a display device according to claim 9, further comprising the step of forming a separation wall which separates the light emitting region in each of the pixels after the step of forming the pixel electrode above the substrate, wherein
the step of forming the transparent electrode above the pixel electrode is the step of forming the transparent electrode so as to cover the separation wall in common with each of the pixels.
